(19) United States
(12) Patent Application Publication
(10) Pub. No.: US 2012/0050527 A1
(43) Pub. Date: Mar. 1, 2012

(54) MICROPHONE STAND ADJUSTMENT SYSTEM AND METHOD

(75) Inventors: Hou-Hsien LEE, Tu-Cheng (TW); Chang-Jung LEE, Tu-Cheng (TW); Chih-Ping LO, Tu-Cheng (TW)

(73) Assignee: HON HAI PRECISION INDUSTRY CO., LTD., Tu-Cheng (TW)

(21) Appl. No.: 13/030,142

(22) Filed: Feb. 18, 2011

(30) Foreign Application Priority Data
Aug. 24, 2010 (TW) 99128174

(51) Int. Cl. H04N 7/18

(52) U.S. Cl. 348/135; 348/E07.085

(57) ABSTRACT

A microphone stand adjustment system and method detects a facial area in a scene image in front of a microphone, and detects a position of a user mouth in the facial area. The system and method further determines if a distance between the microphone and the user is appropriate by determining if an area ratio of the facial area and the scene image equals a preset proportion, and determines if a height and an orientation of the microphone are appropriate by determining if the position of the user mouth is a preset position in the scene image. If the distance, the height, and the orientation are not appropriate, the system and method adjusts the distance between the microphone and the user to the appropriate distance, adjusts the height of the microphone to the appropriate height, and adjusts the orientation to the appropriate orientation.

### BACKGROUND

1. Technical Field

Embodiments of the present disclosure relate generally to multimedia equipment, and more particularly to a microphone stand adjustment system and method.

2. Description of Related Art

Vertically adjustable microphone stands typically utilize a rotatable clutch secured to an upper section of a microphone. In order to adjust the height of the microphone stand, it is necessary to use both hands to loosen the clutch, adjust the upper section, and then retighten the clutch.

There are several disadvantages associated with such manually adjustable microphone stands. For example, a user must often bend over while loosening or tightening the clutch, thereby making it difficult to determine an acceptable height. In addition, the clutch may be loosened when the microphone stand is adjusted.

### BRIEF DESCRIPTION OF THE DRAWINGS

FIG. 1 is a schematic diagram of one embodiment of a microphone stand adjustment system.

FIG. 2 is a schematic diagram illustrating one example of installation of a microphone and the microphone stand adjustment system.

FIG. 3 is a block diagram of one embodiment of function modules of an adjustment unit of the microphone stand adjustment system.

FIG. 4 is a flowchart of one embodiment of a microphone stand adjustment method.

FIG. 5 is a flowchart detailing one block of FIG. 4.

FIG. 6 and FIG. 7 shows an example of a scene image.

FIG. 8 and FIG. 9 show examples of feature detection of a user in a scene image.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

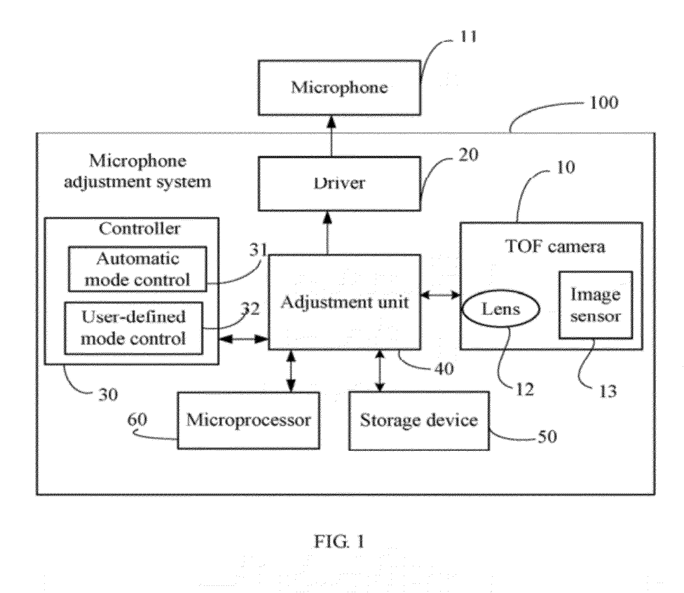

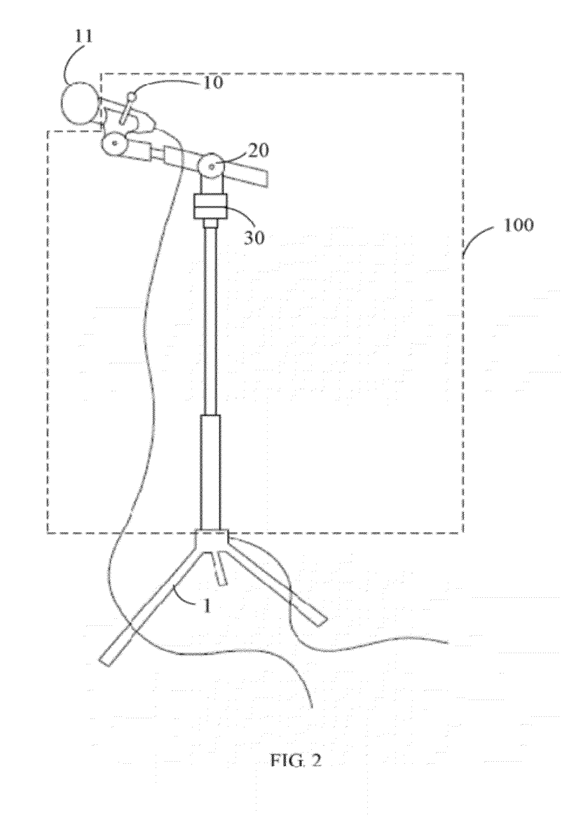

FIG. 1 is a schematic diagram of one embodiment of a microphone stand adjustment system 100 for adjusting a microphone 11. In one embodiment, the microphone stand adjustment system 100 includes a time-of-flight (TOF) camera 10, a driver 20, a controller 30, and an adjustment unit 40. The microphone stand adjustment system 100 may further include a storage device 50 and at least one microprocessor 60. In one example, with respect to FIG. 2, the microphone stand adjustment system 100 is positioned on a base member 1, and the microphone 11 is located at the microphone stand adjustment system 100. Each of the components 10-60 may be embedded in the base member 1. It should be apparent that FIG. 1 illustrates only one example of the microphone stand adjustment system 100, and may include more or fewer components than illustrated, or a different configuration of the various components in other embodiments.

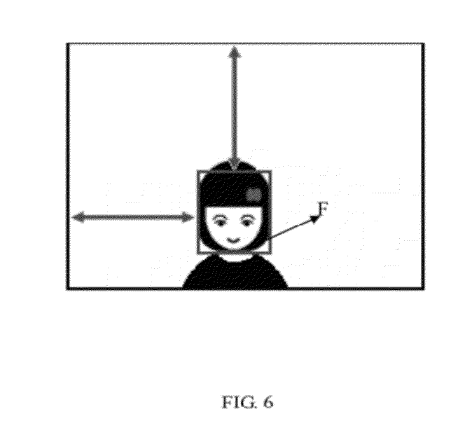

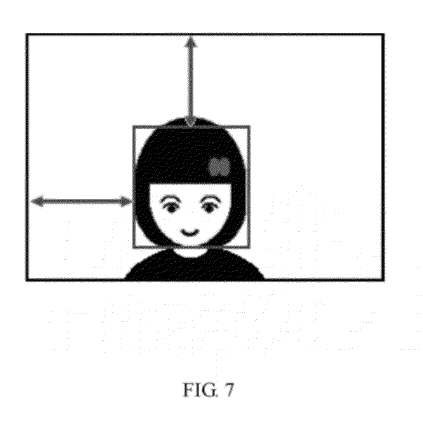

The TOF camera 10 includes a lens 12 and an image sensor 13. It is understood that the TOF camera 10 can obtain a distance between the lens 12 and each point on an object to be captured, for integration with each captured image. Furthermore, the TOF camera 10 and the microphone 11 are preset at and maintain the same height even if the microphone is adjusted. In the embodiment, the TOF camera 10 captures one or more images of a scene (hereinafter, “scene images”) in front of the microphone 11, such as images shown in FIG. 6 and FIG. 7, and sends the scene images to the adjustment unit 40 for analysis.

The controller 30 includes an automatic mode control 31 and a user-defined mode control 32. The controller 30 invokes an automatic mode when the automatic mode control 31 is activated, and invokes a user-defined mode when the user-defined mode control 32 is activated.

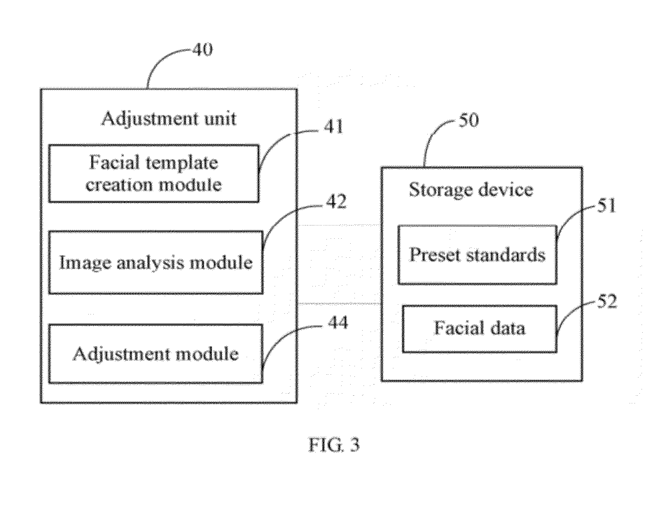

In one embodiment, the adjustment unit 40 includes a number of function modules (depicted in FIG. 3). The function modules may comprise computerized code in the form of one or more programs that are stored in the storage device 50. The computerized code includes instructions that are executed by the at least one microprocessor 60, to analyze the scene images captured by the TOF camera 10, and automatically adjust a position of the microphone 11 to a voice reception position of the microphone 11 based on analysis results of the scene images, so that the microphone 11 receives optimal output from a user. As used herein, the term “voice reception position” is defined as a position that allows the microphone 11 to optimize voice reception from the user, and includes an appropriate height of the microphone 11, an appropriate orientation of microphone 11 towards a mouth of the user, and an appropriate distance between the microphone 11 and the mouth of the user.

The storage device 50 may be an internal storage device, such as a random access memory (RAM) for temporary storage of information, and/or a read only memory (ROM) for permanent storage of information. The storage device 50 may also be an external storage device, such as a hard disk, a storage card, or a data storage medium.

FIG. 3 is a block diagram of one embodiment of function modules of the adjustment unit 40 and the storage device 50. The storage device 50 stores preset standards 51 and 3D facial data 52. The preset standards 51 includes a preset proportion of a facial area to a scene image captured by the TOF camera 10 when the microphone 11 is at the voice reception position, a preset position of the mouth of the user in the scene image, and a preset rule for detecting a current position of the mouth in the facial area. The preset standards 51 may be preset by a manufacturer of the microphone 11, or calculated by the microprocessor 60 based on the scene image captured by the TOF camera 10 if the user prefers the user-defined mode and adjusts the microphone 11 to the voice reception position. The facial data 52 includes facial images pre-captured by the TOF camera 10.

In one embodiment, the adjustment 40 includes a facial template creation module 41, an image analysis module 42, and an adjustment module 43. The modules described herein may be implemented as either software and/or hardware modules and may be stored in any type of computer-readable medium.

The facial template creation module 41 creates a facial template for storing an allowable range for a pixel value of the same feature on faces according to distance information in the facial data 52. For example, the facial template creation module 41 reads a facial image (as shown in FIG. 6), obtains a distance between the lens 12 and each feature (such as the nose) in the facial image. For example, a distance between the lens 12 and the nose may be 61 cm, a distance between the lens 22 and the forehead may be 59 cm.

The facial creation module 31 further converts each distance to a pixel value, for example, 61 cm may be converted to 255, and 59 cm may be converted to 253, and stores the pixel values of the features into a character matrix of the facial image. Furthermore, the facial template creation module 31 aligns all character matrices of the facial images based on a predetermined feature, such as a center of the face in each 3D facial image, and records pixel values of the same feature in different character matrices into the facial template. The pixel values of the same feature in different character matrices are regarded as the allowable range of the pixel value of the same feature. For example, an allowable range of the pixel value of the nose may be [251, 255], and an allowable range of the forehead may be [250, 254].

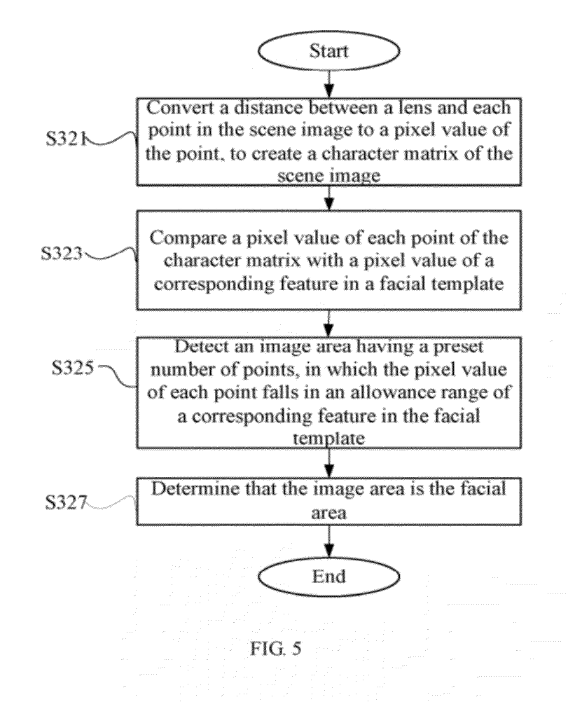

The image analysis module 42 reads a scene image in front of the microphone 11 (such as those in FIG. 5 or FIG. 6) captured by the TOF camera 10, and analyzes the scene image to detect a facial area in the scene image. For example, the image analysis converts a distance between the lens 12 and each point of a scene in the scene image to a pixel value of the point, to create a character matrix of the scene image. The image analysis module 42 compares a pixel value of each point in the character matrix with a pixel value of a corresponding feature in the facial template, and determines if an image area having a preset number (for example, n1) of points in the scene image, where a pixel value of each point in the image area falls within an allowance range of a corresponding feature in the facial template, to determine if the scene image includes a facial area. If the image area is present in the scene image, the image analysis module 42 determines that the image area is the facial area.

Furthermore, the image analysis module 42 determines if an area ratio of the facial area to the scene image equals the first preset proportion (such as 25%), to determine if a distance between the microphone 11 and the user is the appropriate distance. If the area ratio does not equal the first preset proportion, the image analysis module 42 determines that the distance between the microphone 11 and the user is not the appropriate distance, and the adjustment module 43 generates a first command for the driver 20 to adjust the distance between the microphone 11 and the user to the appropriate distance. If the area ratio equals the first preset proportion, the image analysis module 42 determines that the distance between the microphone 11 and the user is the appropriate distance.

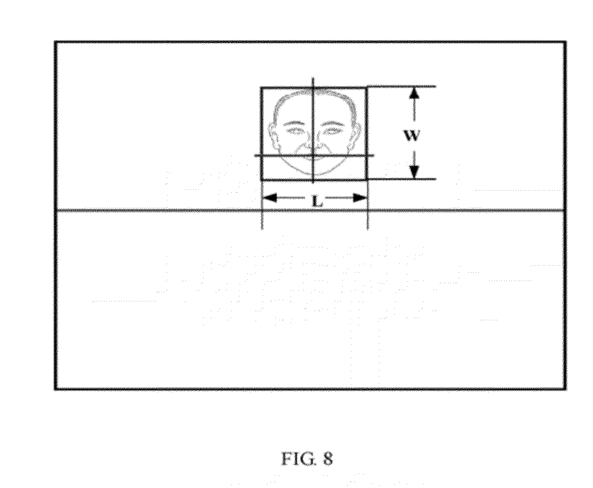

In addition, the image analysis module 42 detects a position of the mouth of the user in the facial area according to the preset rule. In one example with respect to FIG. 8, the facial area may be a rectangle having a length scale “L” and a width scale “W”. The preset rule for detecting the position of the mouth of the user in the facial area may be defined as an intersection between one-second of the length scale (i.e., ½*L) and two-thirds of the width scale (i.e., ⅔*W).

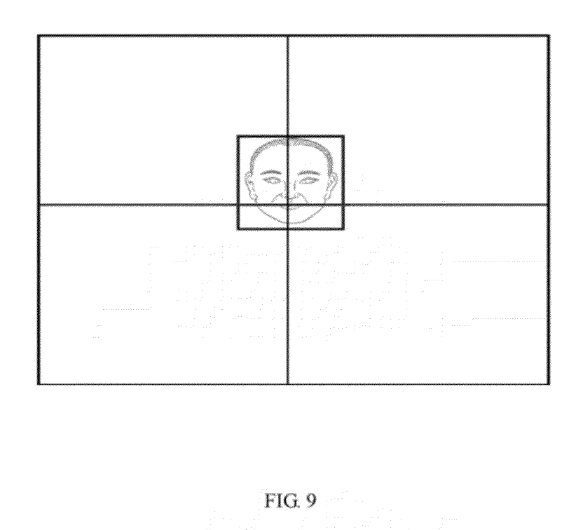

Moreover, the image analysis module 42 determines if the position of the mouth of the user is the preset position in the scene image, to determine if a height of the microphone 11 is the appropriate height and an orientation of the microphone 11 is the appropriate orientation. In one example with respect to FIG. 9, the preset position of the mouth may be defined as a center of the scene image. If the position of the mouth of the user is not the preset position in the scene image, the image analysis module 42 determines that the height of the microphone 11 is not the appropriate height and/or the orientation is not the appropriate orientation, and the adjustment module 43 generates a second command for the driver 20 to adjust the height of the microphone 11 to the appropriate height and the orientation of the microphone 11 to the appropriate orientation. After the distance between the microphone 11 and the user and the height and the orientation of the microphone 11 have been adjusted to the voice reception position, the microphone 11 can receive the appropriate output from the user based upon the voice reception position.

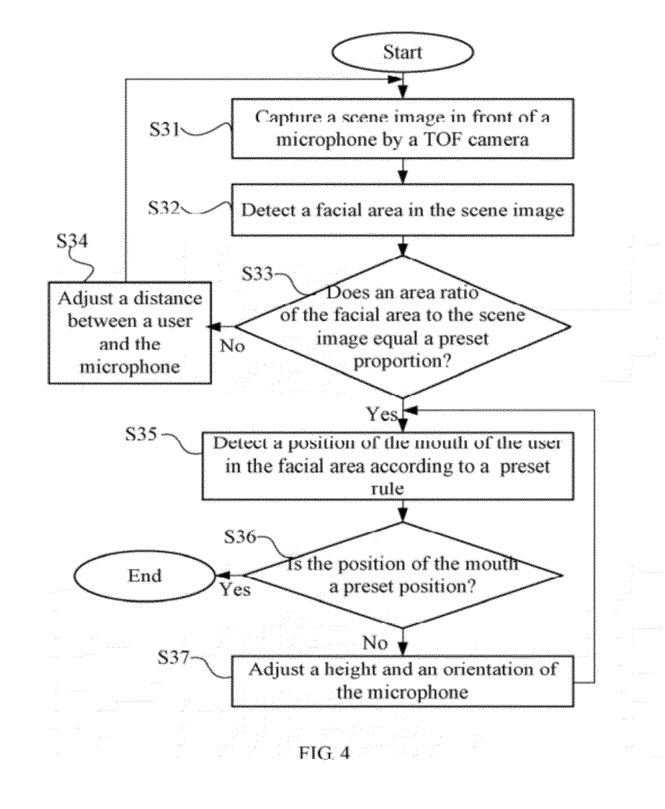

FIG. 4 is a flowchart of one embodiment of a microphone stand adjustment method. Depending on the embodiment, additional blocks may be added, others removed, and the ordering of the blocks may be changed.

In block S31, the TOF camera 10 captures a scene image (such as that shown in FIG. 6) in front of the microphone 11.

In block S32, the image analysis module 41 analyzes the scene image to detect a facial area in the scene image (a detailed description is given in FIG. 5). For example, a rectangle “F” in FIG. 6 is regarded as the facial area.

In block S33, the image analysis module 41 determines if an area ratio of the facial area to the scene image equals a preset proportion of preset standards 51 stored in the storage device 50. The preset proportion is calculated based on a scene image captured by the TOF camera 10 when the microphone 11 is at a voice reception position which the microphone 11 receives optimal output from a user. As mentioned, the term “voice reception position” is defined as a position that allows the microphone 11 to optimize voice reception from the user, and includes an appropriate height of the microphone 11, an appropriate orientation of microphone 11 towards a mouth of the user, and an appropriate distance between the microphone 11 and the mouth of the user. The preset standards 51 further include a preset position of the mouth of the user in the scene image when the microphone 11 is at the voice reception position, and a preset rule for detecting a position of the mouth in the facial area. If the area ratio of the facial area to the scene image does not equal the preset proportion, block S34 is implemented. Otherwise, if the area ratio of the facial area to the scene image equals the preset proportion, block S35 is implemented.

In block S34, the adjustment module 43 generates a first command for the driver 20 to adjust the distance between the microphone 11 and the user, and block S31 is repeated until the area ratio of the facial area to the scene image equals the preset proportion (as shown in FIG. 7), which means that the distance between the microphone 11 and the user has been adjusted to the appropriate distance.

In block S35, the image analysis module 42 detects a position of the mouth of the user in the facial area according to the preset rule. In one example with respect to FIG. 8, the face area may be a rectangle having a length scale “L” and a width scale “W”. The preset rule for detecting the position of the mouth of the user in the face image may be defined as an intersection between one-second of the length scale (i.e., ½*L) and two-thirds of the width scale (i.e., ⅔*W).

In block S36, the image analysis module 42 determines if the position of the mouth of the user is the preset position in the scene image, to determine if a height of the microphone 11 is the appropriate height and if an orientation of the microphone 11 is the appropriate orientation. In one example with respect to FIG. 9, the preset position of the mouth may be defined as a center of the scene image. If the position of the mouth of the user is the preset position, the image analysis module 42 determines that the height of the microphone 11 is the appropriate height and that the orientation of the microphone 11 is the appropriate orientation, whereby the microphone 11 has been adjusted to the voice reception position and the procedure ends. Otherwise, if the position of the mouth of the user is not the preset position, block S37 is implemented.

In block S37, the image analysis module 42 determines that the height of the microphone is not the appropriate height and/or the orientation of the microphone is not the appropriate orientation, and the adjustment module 43 generates a second command for the driver 20 to adjust the height and the orientation of the microphone, and block S35 is repeated until the position of the mouth of the user is the preset position in the scene image. After the adjustments of the distance between the microphone 11 and the user, the height and the orientation of the microphone 11, the microphone 11 has achieved the voice reception position, whereby the microphone 11 can receive the appropriate output from the user based upon the voice reception position.

FIG. 5 is a detailed description of block S32 in FIG. 4. In block S321, the image analysis module 42 converts a distance between the lens 12 and each point of the scene in the scene image to a pixel value of the point, to create a character matrix of the scene image.

In block S323, the image analysis module 42 compares a pixel value of each point in the character matrix with a pixel value of a corresponding feature in the facial template.

In block S325, the image analysis module 42 detects an image area having a preset number (for example, n1) of points in the scene image, where a pixel value of each point in the image area falls within an allowance range of a corresponding feature in the facial template.

In block S327, the image analysis module 42 determines that the image area is the facial area.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A microphone stand adjustment system, the system comprising:
a storage device;
at least one microprocessor;
an adjustment unit comprising one or more computerized codes, which are stored in the storage device and executable by the at least one microprocessor, the one or more computerized codes comprising:
an image analysis module operable to analyze a scene image in front of a microphone to detect a facial area in the scene image, detect a position of a mouth of a user in the facial area according to a preset rule, determine if a distance between the microphone and the user is an appropriate distance by determining if an area ratio of the facial area to the scene image equals a preset proportion, and determine if a height of the microphone is an appropriate height and an orientation of the microphone is an appropriate orientation by determining if the position of the mouth is a preset position in the scene image; and
an adjustment module operable to generate a first command to adjust the distance between the microphone and the user to the appropriate distance, and generate a second command to adjust the height of the microphone to the appropriate height and the orientation to the appropriate orientation, so as to adjust the microphone to a voice reception position.

2. The system as claimed in claim 1, wherein the preset position is defined as a center of the scene image, and the preset rule is defined as an intersection between one-second of the length scale and two-thirds of the width scale of the facial area.

3. The system as claimed in claim 1, wherein the scene image is captured by a time-of-flight (TOF) camera and the scene image comprises distance information between a lens of the TOF camera and each point of objects in a scene.

4. The system as claimed in claim 3, wherein the TOF camera and the microphone are preset at the same height.

5. The system as claimed in claim 3, wherein the storage device further stores preset standards that comprise the preset proportion, the preset position, and the preset rule, and stores facial images pre-captured by the TOF camera.

6. The system as claimed in claim 5, wherein the one or more computerized codes further comprise a facial template creation module operable to create a facial template, which stores an allowable range for a pixel value of the same feature on faces according to distance information in the facial images pre-captured by the TOF camera.

7. The system as claimed in claim 6, wherein creating the facial template comprises:
reading a facial image from the storage device, and obtaining a distance between the lens and each feature of a face in the facial image;
converting each distance to a pixel value of the feature, and storing the pixel values of the features into a character matrix of the facial image; and
aligning all character matrices of the facial images stored in the storage device based on a predetermined feature, and recording pixel values of the same feature in different character matrices into the facial template as the allowable range of the pixel value of the same feature.

8. The system as claimed in claim 7, wherein detecting the facial area in the scene image comprises:
converting a distance between the lens and each point of a scene in the scene image to a pixel value of the point, to create a character matrix of the scene image;
comparing a pixel value of each point in the character matrix with a pixel value of a corresponding feature in the facial template;
determining an image area having a preset number of points is present in the scene image, where a pixel value of each point in the image area falls within an allowance range of a corresponding feature in the facial template; and
determining that the image area is the facial area.

9. A microphone stand adjustment method, comprising:
(a) analyzing a scene image in front of a microphone to detect a facial area in the scene image;
(b) determining if a distance between the microphone and a user is an appropriate distance by determining if an area ratio of the facial area to the scene image equals a preset proportion stored in a storage device, and going to block (d) if the area ratio of the facial area to the scene image equals the preset proportion, or going to block (c) if the area ratio of the facial area to the scene image does not equal the preset proportion;
(c) generating a first command to adjust the distance between the microphone and the user, and returning to block (a);
(d) detecting a position of a mouth of the user in the facial area according to a preset rule stored in the storage device;
(e) determining if a height of the microphone is an appropriate height and an orientation of the microphone is the appropriate orientation by determining if the position of the mouth of the user is at a preset position in the scene image, and going to block (g) if the position of the mouth of the user is the preset position, or going to block (f) if the position of the mouth of the user is not the preset position;
(f) generating a second command to adjust the height and the orientation of the microphone, and returning to block (d); and
(g) determining that the microphone has been adjusted to a voice reception position, on which the distance between the microphone and the user is the appropriate distance, the height of the microphone is the appropriate height, and the orientation of the microphone is the appropriate orientation.

10. The method as claimed in claim 9, wherein the preset position is defined as a center of the scene image, and the preset rule is defined as an intersection between one-second of the length scale and two-thirds of the width scale of the facial area.

11. The method as claimed in claim 9, wherein the scene image is captured by a time-of-flight (TOF) camera and the scene image comprises distance information between a lens of the TOF camera and each point of a scene.

12. The method as claimed in claim 11, wherein the TOF camera and the microphone are preset at the same height.

13. The method as claimed in claim 11, wherein the storage device further stores facial images pre-captured by the TOF camera.

14. The method as claimed in claim 13, before block (a) further comprising:
creating a facial template which stores an allowable range for a pixel value of the same feature on faces according to distance information in the facial images pre-captured by the TOF camera.

15. The method as claimed in claim 13, wherein creating the facial template comprises:
reading a facial image from the storage device, and obtaining a distance between the lens and each feature of a face in the facial image;
converting each distance to a pixel value of the feature, and storing the pixel values of the features into a character matrix of the facial image; and
aligning all character matrices of the facial images stored in the storage device based on a predetermined feature, and recording pixel values of the same feature in different character matrices into the facial template as the allowable range of the pixel value of the same feature.

16. The method as claimed in claim 15, wherein block (a) comprises:
converting a distance between the lens and each point of the scene in the scene image to a pixel value of the point, to create a character matrix of the scene image;
comparing a pixel value of each point in the character matrix with a pixel value of a corresponding feature in the facial template;
determining an image area having a preset number of points is present in the scene image, where a pixel value of each point in the image area falls within an allowance range of a corresponding feature in the facial template; and
determining that the image area is the facial area.
